(19) United States
(12) Patent Application Publication
(10) Pub. No.: US 2024/0055593 A1
(43) Pub. Date: Feb. 15, 2024

(54) HYBRID BATTERY HAVING IMPROVED THERMAL STABILITY AND POWER PERFORMANCE

(71) Applicant: GM GLOBAL TECHNOLOGY OPERATIONS LLC, Detroit, MI (US)

(72) Inventors: Yong LU, Shanghai (CN); Haijing LIU, Shanghai (CN); Jingyuan LIU, Shanghai (CN); Meiyuan WU, Shanghai (CN); Dewen KONG, Shanghai (CN)

(73) Assignee: GM GLOBAL TECHNOLOGY OPERATIONS LLC, Detroit, MI (US)

(21) Appl. No.: 17/980,179

(22) Filed: Nov. 3, 2022

(30) Foreign Application Priority Data
Aug. 12, 2022 (CN) 202210967161.2

(51) Int. Cl. H01M 4/525; H01M 4/505; H01M 4/58; H01M 10/0525

(52) U.S. Cl. CPC H01M 4/525; H01M 4/505; H01M 4/5825; H01M 10/0525; H01M 2004/028

(57) ABSTRACT

The present disclosure provides an electrochemical device that cycles lithium ions. The electrochemical device includes at least one first cell unit and at least one second cell unit. The at least one first cell unit includes a nickel-rich positive electroactive material. The nickel-rich positive electroactive material can be represented by:

LiM¹ₓM²_{y}M³_{z}M⁴_{(1-x-y-z)}O₂

where M¹, M², M³, and M⁴ are each a transition metal independently selected from the group consisting of: nickel, manganese, cobalt, aluminum, and combinations thereof, where 0≤x≤1, 0≤y≤1, and 0≤z≤1. The at least one second cell unit includes a phosphate-based positive electroactive material. The phosphate-based electroactive material can be selected from the group consisting of: lithium manganese iron phosphates (LiMnₓFe₁₋ₓPO₄, where 0≤x≤1) (LMFP), lithium vanadium oxygen phosphates (LiₓVOPO₄, where 0≤x≤1), lithium vanadium phosphates, lithium vanadium fluorophosphates, and combinations thereof.

### CROSS-REFERENCE TO RELATED APPLICATIONS

This application claims the benefit of Chinese Patent Application No. 202210967161.2 filed on Aug. 12, 2022. The entire disclosure of the application referenced above is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator filled with a liquid or solid electrolyte may be disposed between the negative and positive electrodes. The electrolyte is suitable for conducting lithium ions between the electrodes and, like the two electrodes, may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes so that a distinct separator is not required.

Many different materials may be used to create components for a lithium-ion battery. For example, in various aspects, positive electrodes include nickel-rich electroactive materials (e.g., greater than or equal to about 0.6 mole fraction on transition metal lattice), such as NMC (LiNiₓMn_{y}Co_{1-x-y}O₂) (where 0.01≤x≤0.33, 0.01≤y≤0.33) or NCMA (LiNiₓCo_{y}Mn_{z}Al_{1-x-y-z}O₂) (where 0.02≤x≤0.20, 0.01≤y≤0.12, 0.01≤z≤0.08), which are capable of providing improved capacity capability (e.g., greater than 200 mAh/g) while allowing for additional lithium extraction without compromising the structural stability of the positive electrode. Such materials, however, often decompose at low temperatures (e.g., below 300° C.), generating oxygen and boosting various exothermal side reactions within the cell, which can result in thermal propagation and/or runaway. Accordingly, it would be desirable to develop improved materials and/or cell designs, and methods of making and using the same, that can address these challenges.

### SUMMARY

This section provides a general summary of the disclosure, and is not a comprehensive disclosure of its full scope or all of its features.

The present disclosure relates to battery-assisted or hybrid electrochemical devices including first positive electroactive material layers and second positive electroactive material layers that are different form the first positive electroactive material layers, and to methods of making and using the same.

In various aspects, the present disclosure provides an electrochemical device that cycles lithium ions. The electrochemical device may include at least one first cell unit and at least one second cell unit. The at least one first cell unit may include a nickel-rich positive electroactive material. The nickel-rich positive electroactive material may be represented by:

LiM¹ₓM²_{y}M³_{z}M⁴_{(1-x-y-z)}O₂

where M¹, M², M³, and M⁴ are each a transition metal independently selected from the group consisting of: nickel (Ni), manganese (Mn), cobalt (Co), aluminum (Al), and combinations thereof, where 0≤x≤1, 0≤y≤1, and 0≤z≤1. The at least one second cell unit may include a phosphate-based positive electroactive material. The phosphate-based positive electroactive material may be selected from the group consisting of lithium manganese iron phosphates (LiMnₓFe₁₋ₓPO₄, where 0≤x≤1) (LMFP), lithium vanadium oxygen phosphates (LiₓVOPO₄, where 0≤x≤1), lithium vanadium phosphates, lithium vanadium fluorophosphates, and combinations thereof.

In one aspect, the nickel-rich positive electroactive material may define a first positive electroactive material layer and the at least one first cell unit may further include a first negative electroactive material layer physically separated from the first positive electroactive material layer by a first separating layer, the phosphate-based positive electroactive material may define a second positive material layer and the at least one second cell unit may further include a second negative electroactive material layer physically separated from the second positive electroactive material layer by a second separating layer, the first and second negative electroactive material layers may be the same or different, and the first and second separating layers may be the same or different.

In one aspect, the nickel-rich positive electroactive material may define a first nickel-rich positive electroactive material layer, the phosphate-based positive electroactive material may define a first phosphate-based positive electroactive material layer, and the at least one second cell unit may further include a second nickel-rich positive electroactive material layer disposed near or adjacent to the first phosphate-based positive electroactive material layer.

In one aspect, the at least one first cell unit may further include a second phosphate-based positive electroactive material layer disposed near or adjacent to the first nickel-rich positive electroactive material layer.

In one aspect, the phosphate-based positive electroactive material may define a first phosphate-based positive electroactive material layer, the nickel-rich positive electroactive material may define a first nickel-rich positive electroactive material layer, and the at least one first cell unit may further include a second phosphate-based positive electroactive material layer disposed near or adjacent to the first nickel-rich positive electroactive material layer.

In one aspect, a capacity ratio of the nickel-rich positive electroactive material to the phosphate-based positive electroactive material may be greater than or equal to about 0% to less than or equal to about 50%.

In one aspect, the nickel-rich positive electroactive material may define a nickel-rich positive electroactive material layer, and the nickel-rich positive electroactive material layer may further include a second electroactive material. The second electroactive material may be selected from the group consisting of: a layered oxide represented by LiMeO₂, an olivine-type oxide represented by LiMePO₄, a monoclinic-type oxide represented by Li₃Me₂(PO₄)₃, a spinel-type oxide represented by LiMe₂O₄, a tavorite represented by LiMeSO₄F. a tavorite represented by LiMePO₄F. wherein Me is a transition metal selected from the group consisting of: cobalt (Co), nickel (Ni), manganese (Mn), iron (Fe), aluminum (Al), vanadium (V), and combinations thereof.

In one aspect, a mass ratio of the nickel-rich positive electroactive material to the second electroactive material may be greater than or equal to about 5:95 to less than or equal to about 95:5.

In one aspect, the phosphate-based positive electroactive material may define a phosphate-based positive electroactive material layer, and the phosphate-based positive electroactive material layer may further include a second electroactive material. The second electroactive material may be selected from the group consisting of: a layered oxide represented by LiMeO₂, an olivine-type oxide represented by LiMePO₄, a monoclinic-type oxide represented by Li₃Me₂(PO₄)₃, a spinel-type oxide represented by LiMe₂O₄, a tavorite represented by LiMeSO₄F. a tavorite represented by LiMePO₄F, wherein Me is a transition metal selected from the group consisting of: cobalt (Co), nickel (Ni), manganese (Mn), iron (Fe), aluminum (Al), vanadium (V), and combinations thereof.

In one aspect, a mass ratio of the phosphate-based positive electroactive material to the second electroactive material may be greater than or equal to about 5:95 to less than or equal to about 95:5.

In various aspects, the present disclosure provides an electrochemical device that cycles lithium ions. The electrochemical device may include a first positive electrode that includes a nickel-rich positive electroactive material, a first negative electrode disposed parallel with the first positive electrode and including a first negative electroactive material, a first separating layer disposed between the first positive electrode and the first negative electrode, a second positive electrode disposed parallel with the first positive electrode and the first negative electrode and including a phosphate-based positive electroactive material, a second negative electrode disposed parallel with the second positive electrode and including a second negative electroactive material, and a second separating layer disposed between the second positive electrode and the second negative electrode. The nickel-rich positive electroactive material may be represented by:

LiM¹ₓM²_{y}M³_{z}M⁴_{(1-x-y-z)}O₂

where M¹, M², M³, and M⁴ are each a transition metal independently selected from the group consisting of: nickel (Ni), manganese (Mn), cobalt (Co), aluminum (Al), and combinations thereof, where 0≤x≤1, 0≤y≤1, and 0≤z≤1. The phosphate-based positive electroactive material may be selected from the group consisting of: lithium manganese iron phosphates (LiMnₓFe₁₋ₓPO₄, where 0≤x≤1) (LMFP), lithium vanadium oxygen phosphates (LiₓVOPO₄, where 0≤x≤1), lithium vanadium phosphates, lithium vanadium fluorophosphates, and combinations thereof. The second negative electroactive material may be the same as or different from the first negative electroactive materials, and the first and second separating layers may be the same or different.

In one aspect, the nickel-rich positive electrode material defines a first nickel-rich positive electrode material layer, and the phosphate-based positive electroactive material defines a first phosphate-based positive electroactive material layer, and the at least one first positive electrode further comprises a second phosphate-based positive electroactive material layer disposed near or adjacent to the first nickel-rich positive electrode material layer.

In one aspect, the at least one second positive electrode may further include a second nickel-rich positive electrode material layer disposed near or adjacent to the first phosphate-based positive electroactive material layer.

In one aspect, a capacity ratio of the nickel-rich positive electroactive material to the phosphate-based positive electroactive material may be greater than or equal to about 0% to less than or equal to about 50%.

In one aspect, the nickel-rich positive electroactive material may define a nickel-rich positive electroactive material layer, and the nickel-rich positive electroactive material layer may further include a second electroactive material. The second electroactive material may be selected from the group consisting of: a layered oxide represented by LiMeO₂, an olivine-type oxide represented by LiMePO₄, a monoclinic-type oxide represented by Li₃Me₂(PO₄)₃, a spinel-type oxide represented by LiMe₂O₄, a tavorite represented by LiMeSO₄F, a tavorite represented by LiMePO₄F, wherein Me is a transition metal selected from the group consisting of: cobalt (Co), nickel (Ni), manganese (Mn), iron (Fe), aluminum (Al), vanadium (V), and combinations thereof.

In one aspect, a mass ratio of the nickel-rich positive electroactive material to the second electroactive material may be greater than or equal to about 5:95 to less than or equal to about 95:5.

In one aspect, the phosphate-based positive electroactive material may define a phosphate-based positive electroactive material layer. The phosphate-based positive electroactive material laver may further include a second electroactive material. The second electroactive material may be selected from the group consisting of: a layered oxide represented by LiMeO₂, an olivine-type oxide represented by LiMePO₄, a monoclinic-type oxide represented by Li₃Me₂(PO₄)₃, a spinel-type oxide represented by LiMe₂O₄, a tavorite represented by LiMeSO₄F, a tavorite represented by LiMePO₄F, wherein Me is a transition metal selected from the group consisting of: cobalt (Co), nickel (Ni), manganese (Mn), iron (Fe), aluminum (Al), vanadium (V), and combinations thereof.

In one aspect, a mass ratio of the phosphate-based positive electroactive material to the second electroactive material may be greater than or equal to about 5:95 to less than or equal to about 95:5.

In various aspects, the present disclosure provides an electrode assembly for an electrochemical cell that cycles lithium ions. The electrode may include a current collector, a first electroactive material layer disposed on or near the current collector, and a second electroactive material layer disposed on or near a surface of the first electroactive material layer on a side opposite to the current collector. The first electroactive material layer may include one of a nickel-rich positive electroactive material and a phosphate-base positive electroactive material, where the second electroactive material layer includes the other of the nickel-rich positive electroactive material and the phosphate-based positive electroactive material. The nickel-rich positive electroactive material represented by:

LiM¹ₓM²_{y}M³_{z}M⁴_{(1-x-y-z)}O₂

where M¹, M², M³, and M⁴ are each a transition metal independently selected from the group consisting of: nickel (Ni), manganese (Mn), cobalt (Co), aluminum (Al), and combinations thereof, wherein 0≤x≤1, 0≤y≤1, and 0≤z≤1. The phosphate-based positive electroactive material may be selected from the group consisting of: lithium manganese iron phosphates (LiMnₓFe₁₋ₓPO₄, where 0≤x≤1) (LMFP), lithium vanadium oxygen phosphates (LiₓVOPO₄, where 0≤x≤1), lithium vanadium phosphates, lithium vanadium fluorophosphates, and combinations thereof.

Corresponding reference numerals indicate corresponding parts throughout the several views of the drawings.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical cell unit including a positive electrode including a first positive electroactive material layer and a second positive electroactive material layer that is different from the first positive electroactive material layer in accordance with various aspects of the present disclosure:

FIG. 2 is a schematic of an example electrochemical battery including a first battery cell unit including a first positive electroactive material layer and a second battery cell unit including a second positive electroactive material layer that is different from the first positive electroactive material layer in accordance with various aspects of the present disclosure;

FIG. 3 is a schematic of an example electrochemical battery including a first battery cell unit including a first positive electroactive material layer and a second positive electroactive material layer that is different from the first positive electroactive material layer, a second battery unit cell including a third positive electroactive material layer, and a third battery cell unit including a fourth positive electroactive material layer that is different from the third positive electroactive material layer in accordance with various aspects of the present disclosure:

FIG. 4A is a graphical illustration demonstrating the initial charge and discharge curves of an example battery including a first battery cell unit including a first positive electroactive material layer and a second battery cell unit including a second positive electroactive material layer that is different from the first positive electroactive material layer in accordance with various aspects of the present disclosure;

FIG. 4B is a graphical illustration demonstrating the discharge rate (charge at 0.2 C) of an example battery including a first battery cell including a first positive electroactive material layer and a second battery cell including a second positive electroactive material layer that is different from the first positive electroactive material layer in accordance with various aspects of the present disclosure:

FIG. 5A is a graphical illustration demonstrating the initial charge and discharge curves of an example battery including a positive electrode including a first positive electroactive material layer and a second positive electroactive material layer that is different form the first positive electroactive material layer in accordance with various aspects of the present disclosure; and

FIG. 5B is a graphical illustration demonstrating the discharge rate (charge at 0.2 C) of an example battery including a positive electrode including a first positive electroactive material layer and a second positive electroactive material layer that is different form the first positive electroactive material layer in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to.” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates both exactly or precisely the stated numerical value, and also, that the stated numerical value allows some slight imprecision (with some approach to exactness in the value, approximately or reasonably close to the value, nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present technology relates to electrochemical cells including a functional hybrid powder additive, and also, to methods of forming and using the same. Such cells can be used in vehicle or automotive transportation applications (e.g., motorcycles, boats, tractors, buses, motorcycles, mobile homes, campers, and tanks). However, the present technology may also be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples detail below include a single positive electrode cathode and a single anode, the skilled artisan will recognize that the present teachings also extend to various other configurations, including those having one or more cathodes and one or more anodes, as well as various current collectors with electroactive layers disposed on or adjacent to one or more surfaces thereof.

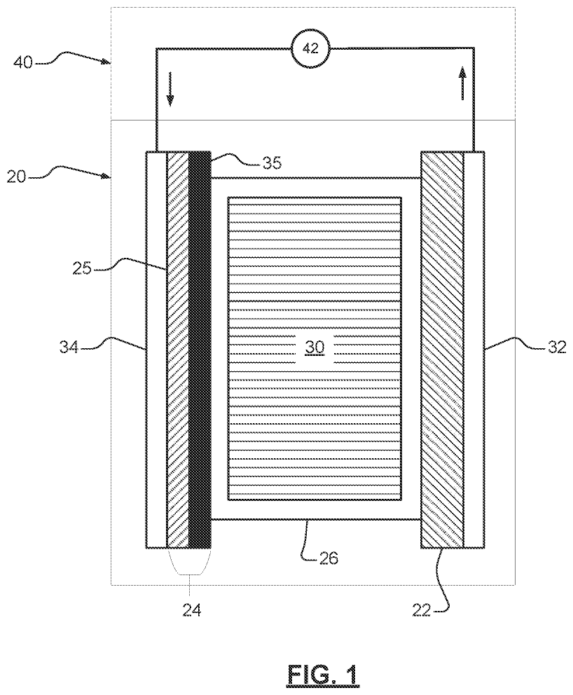

An exemplary and schematic illustration of an electrochemical cell (also referred to as a battery) 20 is shown in FIG. 1. The battery 20 includes a negative electrode 22 (e.g., anode), a positive electrode 24 (e.g., cathode), and a separator 26 disposed between the two electrodes 22, 24. The separator 26 provides electrical separation—prevents physical contact—between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and/or the positive electrode 24, so as to form a continuous electrolyte network. In certain variations, the separator 26 may be formed by a solid-state electrolyte or a semi-solid-state electrolyte (e.g., gel electrolyte). For example, the separator 26 may be defined by a plurality of solid-state electrolyte particles. In the instance of solid-state batteries and/or semi-solid-state batteries, the positive electrode 24 and/or the negative electrode 22 may include a plurality of solid-state electrolyte particles. The plurality of solid-state electrolyte particles included in, or defining, the separator 26 may be the same as or different from the plurality of solid-state electrolyte particles included in the positive electrode 24 and/or the negative electrode 22.

A first current collector 32 (e.g., a negative current collector) may be positioned at or near the negative electrode 22. The first current collector 32 together with the negative electrode 22 may be referred to as a negative electrode assembly. Although not illustrated, the skilled artisan will appreciate that, in certain variations, negative electrodes 22 (also referred to as negative electroactive material layers) may be disposed on one or more parallel sides of the first current collector 32. Similarly, the skilled artisan will appreciate that, in other variations, a negative electroactive material layer may be disposed on a first side of the first current collector 32, and a positive electroactive material layer may be disposed on a second side of the first current collector 32. In each instance, the first current collector 32 may include a metal foil, metal grid or screen, expanded metal comprising copper, or any other appropriate electrically conductive material known to those of skill in the art.

A second current collector 34 (e.g., a positive current collector) may be positioned at or near the positive electrode 24. The second current collector 34 together with the positive electrode 24 may be referred to as a positive electrode assembly. Although not illustrated, the skilled artisan will appreciate that, in certain variations, positive electrodes 24 (also referred to as positive electroactive material layers) may be disposed on one or more parallel sides of the second current collector 34. Similarly, the skilled artisan will appreciate that, in other variations, a positive electroactive material layer may be disposed on a first side of the second current collector 34, and a negative electroactive material layer may be disposed on a second side of the second current collector 34. In each instance, the second electrode current collector 34 may include a metal foil, metal grid or screen, expanded metal comprising aluminum, or any other appropriate electrically conductive material known to those of skill in the art.

The first current collector 32 and the second current collector 34 may respectively collect and move free electrons to and from an external circuit 40. For example, an interruptible external circuit 40 and a load device 42 may connect the negative electrode 22 (through the first current collector 32) and the positive electrode 24 (through the second current collector 34). The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 toward the positive electrode 24. Lithium ions that are also produced at the negative electrode 22 are concurrently transferred through the electrolyte 30 contained in the separator 26 toward the positive electrode 24. The electrons flow through the external circuit 40 and the lithium ions migrate across the separator 26 containing the electrolyte 30 to form intercalated lithium at the positive electrode 24. As noted above, the electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back toward the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the first current collector 32, negative electrode 22, separator 26, positive electrode 24, and second current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the present technology also applies to solid-state batteries and/or semi-solid state batteries that include solid-state electrolytes and/or solid-state electrolyte particles and/or semi-solid electrolytes and/or solid-state electroactive particles that may have different designs as known to those of skill in the art.

The size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, in certain aspects, the electrolyte 30 may be a non-aqueous liquid electrolyte solution (e.g., >1 M) that includes a lithium salt dissolved in an organic solvent or a mixture of organic solvents. Numerous conventional non-aqueous liquid electrolyte 30 solutions may be employed in the battery 20.

A non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof. These and other similar lithium salts may be dissolved in a variety of non-aqueous aprotic organic solvents, including but not limited to, various alkyl carbonates, such as cyclic carbonates (e.g., ethylene carbonate (EC), propylene carbonate (PC), butylene carbonate (BC), fluoroethylene carbonate (FEC), vinylene carbonate (VC), and the like), linear carbonates (e.g., dimethyl carbonate (DMC), diethyl carbonate (DEC), ethylmethylcarbonate (EMC), and the like), aliphatic carboxylic esters (e.g., methyl formate, methyl acetate, methyl propionate, and the like), γ-lactones (e.g., γ-butyrolactone, γ-valerolactone, and the like), chain structure ethers (e.g., 1,2-dimethoxyethane, 1-2-diethoxyethane, ethoxymethoxyethane, and the like), cyclic ethers (e.g., tetrahydrofuran, 2-methyltetrahydrofuran, 1,3-dioxolane, and the like), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD® 2320 (a trilayer polypropylene/polyethylene/polypropylene separator) available from Celgard LLC.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics.

In certain aspects, the separator 26 may further include one or more of a ceramic material and a heat-resistant material. For example, the separator 26 may also be admixed with the ceramic material and/or the heat-resistant material, or one or more surfaces of the separator 26 may be coated with the ceramic material and/or the heat-resistant material. In certain variations, the ceramic material and/or the heat-resistant material may be disposed on one or more sides of the separator 26. The ceramic material may be selected from the group consisting of: alumina (Al₂O₃), silica (SiO₂), and combinations thereof. The heat-resistant material may be selected from the group consisting of: Nomex, Aramid, and combinations thereof.

Various conventionally available polymers and commercial products for forming the separator 26 are contemplated, as well as the many manufacturing methods that may be employed to produce such a microporous polymer separator 26. In each instance, the separator 26 may have an average thickness greater than or equal to about 1 micrometer (μm) to less than or equal to about 50 μm, and in certain instances, optionally greater than or equal to about 1 μm to less than or equal to about 20 μm.

In various aspects, the porous separator 26 and/or the electrolyte 30 disposed in the porous separator 26 as illustrated in FIG. 1 may be replaced with a solid-state electrolyte (“SSE”) and/or semi-solid-state electrolyte (e.g., gel) that functions as both an electrolyte and a separator. For example, the solid-state electrolyte and/or semi-solid-state electrolyte may be disposed between the positive electrode 24 and negative electrode 22. The solid-state electrolyte and/or semi-solid-state electrolyte facilitates transfer of lithium ions, while mechanically separating and providing electrical insulation between the negative and positive electrodes 22, 24. By way of non-limiting example, the solid-state electrolyte and/or semi-solid-state electrolyte may include a plurality of fillers, such as LiTi₂(PO₄)₃, LiGe₂(PO₄)₃, Li₇La₃Zr₂O₁₂, Li₃xLa_{2/3}-xTiO₃, Li₃PO₄, Li₃N, Li₄GeS₄, Li₁₀GeP₂S₁₂, Li₂S—P₂S₅, Li₆PS₅Cl, Li₆PS₅Br, Li₆PS₅I, Li₃OCl, Li_{2.99} Ba_{0.005}ClO, or combinations thereof. The semi-solid-state electrolyte may include a polymer host and a liquid electrolyte. The polymer host may include, for example, polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. In certain variations, the semi-solid or gel electrolyte may also be found in the positive electrode 24 and/or the negative electrodes 22. In each instance, the solid-state electrolyte and/or semi-solid-state electrolyte includes the electrolyte additive as detailed above.

The negative electrode 22 is formed from a lithium host material that is capable of functioning as a negative terminal of a lithium-ion battery. In various aspects, the negative electrode 22 may be defined by a plurality of negative electroactive material particles. Such negative electroactive material particles may be disposed in one or more layers so as to define the three-dimensional structure of the negative electrode 22. The electrolyte 30 may be introduced, for example after cell assembly, and contained within pores of the negative electrode 22. For example, in certain variations, the negative electrode 22 may include a plurality of solid-state electrolyte particles. In each instance, the negative electrode 22 (including the one or more layers) may have an average thickness greater than or equal to about 1 μm to less than or equal to about 1,000 μm, and in certain aspects, optionally greater than or equal to about 10 μm to less than or equal to about 200 μm.

In various aspects, negative electrode 22 may include a lithium-containing negative electroactive material, such as a lithium alloy and/or a lithium metal. For example, in certain variations, the negative electrode 22 may be defined by a lithium metal foil. In other variations, the negative electrode 22 may include, for example only, carbonaceous materials (such as, graphite, hard carbon, soft carbon, and the like) and/or metallic active materials (such as tin, aluminum, magnesium, germanium, and alloys thereof, and the like) and/or metal oxides (such as SnO₂, Fe₃O₄, and the like). In further variations, the negative electrode 22 may include a silicon-based electroactive material (such as silicon (Si), silicon oxide (SiOₓ, 0≤x≤2), and the like). In still further variations, the negative electrode 22 may be a composite electrode including a combination of negative electroactive materials. For example, the negative electrode 22 may include a first negative electroactive material and a second negative electroactive material. In certain variations, a mass ratio of the first negative electroactive material to the second negative electroactive material may be greater than or equal to about 5:95 to less than or equal to about 95:5. The first negative electroactive material may be a volume-expanding material including, for example, silicon, aluminum, germanium, and/or tin. The second negative electroactive material may include a carbonaceous material (e.g., graphite, hard carbon, and/or soft carbon) For example, in certain variations, the negative electroactive material may include a carbonaceous-silicon based composite including, for example, about 10 wt. % SiOₓ (where 0≤x≤2) and about 90 wt. % graphite. In each instance, the negative electroactive material may be prelithiated.

In certain variations, the negative electroactive material may be optionally intermingled (e.g., slurry casted) with an electronically conductive material (i.e., conductive additive) that provide an electron conductive path and/or a polymeric binder material that improve the structural integrity of the negative electrode 22. For example, the negative electrode 22 may include greater than or equal to about 30 wt. % to less than or equal to about 99.5 wt. %, and in certain aspects, optionally greater than or equal to about 60 wt. % to less than or equal to about 95 wt. %, of the negative electroactive material, greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.01 wt. % to less than or equal to about 10 wt. %, of the polymeric binder.

Example polymeric binders include polyimide, polyamic acid, polyamide, polysulfone, polyvinylidene difluoride (PVdF), polytetrafluoroethylene (PTFE), polyacrylic acid (PAA), blends of polyvinylidene fluoride and polyhexafluoropropene, polychlorotrifluoroethylene, ethylene propylene diene monomer (EPDM) rubber, carboxymethyl cellulose (CMC), nitrile butadiene rubber (NBR), styrene-butadiene rubber (SBR), lithium polvacrylate (LiPAA), sodium polyacrylate (NaPAA), styrene ethylene butylene styrene copolymer (SEBS), styrene butadiene styrene copolymer (SBS), sodium alginate, and/or lithium alginate. Electronically conducting materials may include, for example, carbon-based materials, powdered nickel or other metal particles, or conductive polymers. Carbon-based materials may include, for example, particles of graphite, acetylene black (such as KETCHEN™ black or DENKA™ black), carbon nanofibers and nanotubes (e.g., single wall carbon nanotubes (SWCNT), multiwall carbon nanotubes (MWCNT)), graphene (e.g., graphene platelets (GNP), oxidized graphene platelets), conductive carbon blacks (such as, SuperP (SP)), and the like. Example conductive polymers include polyaniline, polythiophene, polyacetylene, polypyrrole, and the like.

The positive electrode 24 may be a hybrid layer (or bilayer) that includes a first electroactive material layer 25 disposed near or adjacent to, and substantially parallel, with a second electroactive material layer 35. Each of the electroactive material layers 25, 35 may be formed from lithium-based active materials capable of undergoing lithium intercalation and deintercalation, alloying and dealloying, or plating and stripping, while functioning as the positive terminal of a lithium-ion battery. The first electroactive material layer 25 may be defined by a plurality of first electroactive material particles disposed so as to define the three-dimensional structure of the first electroactive material layer 25. The second electroactive material layer 35 may be defined by a plurality of second electroactive material particles so as to define the three-dimensional structure of the second electroactive material layer 35. The electrolyte 30 may be introduced, for example after cell assembly, and contained within pores one or both of the first and second electroactive material layers 25, 35. In certain variations the plurality of first electroactive material particles and/or the plurality of second electroactive material particles may be intermingled with a plurality of solid-state electrolyte particles. In each instance, the first and second electroactive material layers 25, 35 may have average thicknesses greater than or equal to about 1 μm to less than or equal to about 1,000 μm, and in certain aspects, optionally greater than or equal to about 10 μm to less than or equal to about 200 μm.

In various aspects, the first electroactive material layer 25 may be a nickel-rich electroactive material layer including a nickel-rich positive electroactive material represented by:

LiM¹ₓM²_{y}M³_{z}M⁴_{(1-x-y-z)}O₂

where M1, M2, M3, and M4 are transitions metals (for example, independently selected from the group consisting of: nickel (Ni), manganese (Mn), cobalt (Co), aluminum(Al), iron (Fe), and combinations thereof), 0≤x≤1, 0≤y≤1, and 0≤z≤1. For example, the positive electrode 24 may include NMC (LiNi_{1-x-y}CoₓMn_{y}O₂) (where 0≤x≤0.33, 0≤y≤0.33), NCMA (LiNi_{1-x-y-z}CoₓMn_{y}Al_{z}O₂) (where 0.02≤x≤0.20, 0.01≤y≤0.12, 0.01≤z≤0.08), and/or LiNi_{1-x-y}CoₓAl_{y}O₂ (where 0≤x≤1, 0≤y≤1). The positive electrode 24 may include NCM 111. NCM 532, NCM 622, NCM 712, NCM 811, NCMA, NCA, LNMO, and combinations thereof. In certain variations, the nickel-rich positive electroactive material(s) may be surface coated (e.g., LiNbO₃ coating and/or carbon coating) and/or doped (e.g., non-metal doping).

In other variations, the first electroactive material layer 25 may be a composite layer including two or more positive electroactive materials. For example, the first electroactive material layer 25 may include a first positive electroactive material and a second positive electroactive material. In certain variations, a mass ratio of the first positive electroactive material to the second positive electroactive material may be greater than or equal to about 1:9 to less than or equal to about 9:1. The first positive electroactive material may include, for example, a nickel-rich positive electroactive material, such as detailed above. The second positive electroactive material may include, for example, a layered oxide represented by LiMeO₂, where Me is a transition metal, such as cobalt (Co), nickel (Ni), manganese (Mn), aluminum (Al), and the like or combinations thereof; an olivine-type oxide represented by LiMePO₄, where Me is a transition metal, such as cobalt (Co), manganese (Mn), iron (Fe), aluminum (Al), vanadium (V), and the like or combinations thereof; a monoclinic-type oxide represented by Li₃Me₂(PO₄)₃, where Me is a transition metal, such as cobalt (Co), manganese (Mn), iron (Fe), aluminum (Al), vanadium(V), and the like or combinations thereof; a spinel-type oxide represented by LiMe₂O₄, where Me is a transition metal, such as nickel (Ni), manganese (Mn), and the like or combinations thereof; and/or a tavorite represented by LiMeSO₄F and/or LiMePO₄F, where Me is a transition metal, such as cobalt (Co), manganese (Mn), iron (Fe), aluminum (Al), vanadium (V), and the like or combinations thereof.

In each instance, the first electroactive material layer 25 may be optionally intermingled (e.g., slurry casted) with an electronically conductive material (i.e. conductive additive) that provide an electron conductive path and/or a polymeric binder material that improve the structural integrity of the first electroactive material layer 25 and/or the positive electrode 24. For example, the first electroactive material layer 25 may include greater than or equal to about 30 wt. % to less than or equal to about 98 wt. %, and in certain aspects, optionally greater than or equal to about 60 wt. % to less than or equal to about 97 wt. %, of the positive electroactive material(s); greater than or equal to 0 wt. % to less than or equal to about 30 w and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder. The conductive additive and/or binder material as included in the first electroactive material layer 25 may be the same as or different from the conductive additive and/or binder material as included in the negative electrode 22.

In various aspects, the second electroactive material layer 35 may be a phosphate-based electroactive material layer including, for example, lithium manganese iron phosphates (LiMnₓFe₁₋ₓPO₄, where 0≤x≤1) (LMFP) (such as LiMn_{0.7}Fe_{0.3}PO₄, LiMn_{0.6}Fe_{0.4}PO₄, LiMn_{0.8}Fe_{0.2}PO₄, and/or LiMn_{0.75}Fe_{0.25}PO₄), lithium vanadium oxygen phosphates (LiₓVOPO₄, where 0≤x≤1) (such as LiVOPO₄ and/or Li₂VOPO₄), lithium vanadium phosphates (Li₃V₂(PO₄)₃), and/or lithium vanadium fluorophosphates (LiVPO₄F). In certain variations, the phosphate-based electroactive material(s) may be surface coated (e.g., LiNbO₃ coating and/or carbon coating) and/or doped (e.g., non-metal doping).

In other variations, the second electroactive material layer 35 may be a composite layer including two or more positive electroactive materials. For example, the second electroactive material layer 35 may include a first positive electroactive material and a second positive electroactive material. In certain variations, a mass ratio of the first positive electroactive material to the second positive electroactive material may be greater than or equal to about 1:9 to less than or equal to about 9:1. The first positive electroactive material may include, for example, a phosphate-based electroactive material, such as detailed above. The second positive electroactive material may include, for example, a layered oxide represented by LiMeO₂, where Me is a transition metal, such as cobalt (Co), nickel (Ni), manganese (Mn), iron (Fe), aluminum (Al), vanadium (V), and the like or combinations thereof, an olivine-type oxide represented by LiMePO₄, where Me is a transition metal, such as cobalt (Co), manganese (Mn), iron (Fe), aluminum (Al), vanadium (V), and the like or combinations thereof: a monoclinic-type oxide represented by Li₃Me₂(PO₄)₃, where Me is a transition metal, such as cobalt (Co), manganese (Mn), iron (Fe), aluminum (Al), vanadium (V), and the like or combinations thereof; a spinel-type oxide represented by LiMe₂O₄, where Me is a transition metal, such as nickel (Ni), manganese (Mn), and the like or combinations thereof; and/or a tavorite represented by LiMeSO₄F and/or LiMePO₄F, where Me is a transition metal, such as cobalt (Co), manganese (Mn), iron (Fe), aluminum (Al), vanadium (V), and the like or combinations thereof. In each instance, the phosphate-based electroactive material layers may help to block heat transport while the battery 20 experiences abused conditions, and incorporation of phosphate-based electroactive materials may help to more uniformly distribution heat within the cell 20, because the phosphate-based electroactive material with strong phosphorus-oxygen (P—O) bonding has higher high decomposition temperature and generates less heat, and release less oxygen, under abuse conditions. Thus, the hybrid structure of phosphate-based electroactive material layers and high-nickel electroactive material layers can enhance the thermal stability of the battery 20.

The second electroactive material layer 35 may be optionally intermingled (e.g., slurry casted) with an electronically conductive material (i.e., conductive additive) that provide an electron conductive path and/or a polymeric binder material that improve the structural integrity of the second electroactive material layer 35 and/or the positive electrode 24. For example, the second electroactive material layer 35 may include greater than or equal to about 30 wt. % to less than or equal to about 98 wt. %, and in certain aspects, optionally greater than or equal to about 60 wt. % to less than or equal to about 97 wt. %, of the positive electroactive material(s); greater than or equal to 0 wt. % to less than or equal to about 30 wt. %, and in certain aspects, optionally greater than or equal to about 0.5 wt. % to less than or equal to about 10 wt. %, of the electronically conducting material; and greater than or equal to 0 wt. % to less than or equal to about 20 wt. %, and in certain aspects, optionally greater than or equal to about 0.5 wt. % to less than or equal to about 10 wt. %, of the polymeric binder. The conductive additive and/or binder material as included in the second electroactive material layer 35 may be the same as or different from the conductive additive and/or binder material as included in the negative electrode 22 and the same as or different from the conductive additive and/or binder material as include in the first electroactive material layer 25.

Although in the illustrated example in FIG. 1 shows the first electroactive material layer 25 of the positive electrode 24 disposed near or adjacent to the positive electrode current collector 34 and the second electroactive material layer 35 of the positive electrode 24 disposed near or adjacent to a surface of the first electroactive material layer 25 away from the positive electrode current collector 34, it should be recognized that in certain variations, the second electroactive material layer 35 can be disposed near or adjacent to the positive electrode current collector 34 and the first electroactive material layer 25 will be disposed near or adjacent to a surface of the second electroactive material layer 35 away from the positive electrode current collector 34. Similarly, in certain variations, the positive electrode 24 may include two or more of the first electroactive material layers 34 and/or two or more of the second electroactive material layer 35. In each instance, a hybrid capacity ratio of the nickel-rich positive electroactive material of the first electroactive material layer 25 to the phosphate-based electroactive material of the second electroactive material layer 35 may be greater than or equal to 0:50 to less than or equal to about 50:0. The areal capacity loading of the nickel-rich positive electroactive material in the first electroactive material layer 25 and the loading of the phosphate-based electroactive material in the second electroactive material layer 35 will be dependent upon the hybrid capacity ratio.

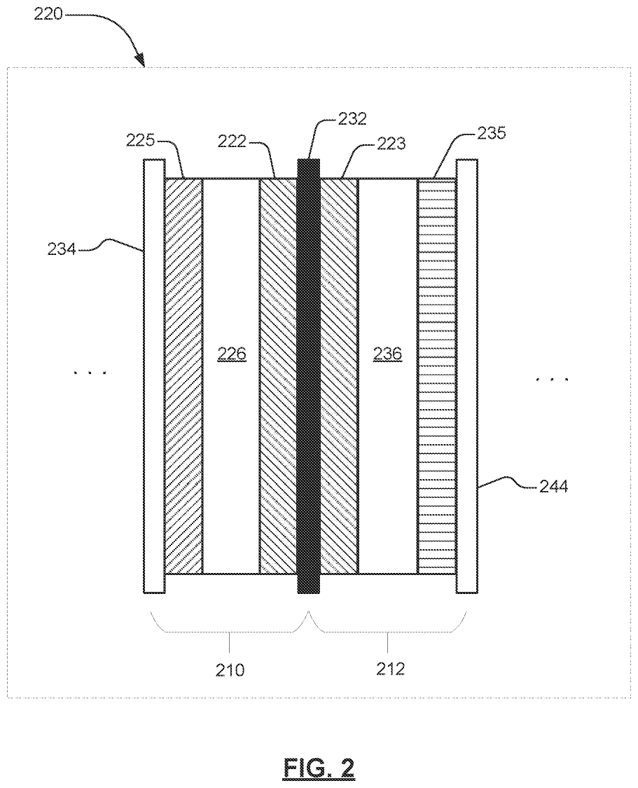

FIG. 2 illustrates another example electrochemical battery 220. The example battery 220 may include one or more negative electrodes 222, 223 (that are like the negative electrode 22 illustrated in FIG. 1) together with one or more first positive electrodes that are defined by first positive electroactive material layers 225 (that are like the first positive electroactive material layers 25 illustrated in FIG. 1) and one or more second positive electrodes that are defined by second positive electroactive material layers 235 (that are like the second positive electroactive material layers 35 illustrated in FIG. 1). Although only two cell units 210, 212 are illustrated, it should be recognized, as illustrated by the ellipsis, that the present teachings also apply to various other battery configurations, including batteries having three or more cell units.

A first battery cell unit 210 may include a first positive electrode current collector 234 and a first positive electroactive material layer 225 disposed near or adjacent to a surface of the first positive electrode current collector 234. Like positive electrode current collector 34 illustrated in FIG. 1, the first positive electrode current collector 234 may include a metal foil, metal grid or screen, expanded metal comprising aluminum, or any other appropriate electrically conductive material known to those of skill in the art. Like the first positive electroactive material layer 25 illustrated in FIG. 1, the first positive electroactive material layer 225 may include a nickel-rich positive electroactive material represented by:

LiM¹ₓM²_{y}M³_{z}M⁴_{(1-x-y-z)}O₂

where M1, M2, M3, and M4 are transitions metals (for example, independently selected from the group consisting of: nickel (Ni), manganese (Mn), cobalt (Co), aluminum (Al), and the like or combinations thereof), 0≤x≤1, 0≤y≤1, and 0≤z≤1.

The first cell unit 210 may also include a first negative electrode assembly defined by a negative electrode current collector 232 and a first negative electrode 222 (also referred to as a first negative electroactive material layer) disposed near or adjacent to a first side of the negative electrode current collector 232, which like the negative electrode current collector 32 illustrated in FIG. 1, may include a metal foil, metal grid or screen, expanded metal comprising aluminum, or any other appropriate electrically conductive material known to those of skill in the art. Further still, as in FIG. 1, a first separating layer 226 may physically separate the first positive electrode assembly and the first negative electrode assembly, and the separating layer 226 and/or the first positive electrode assembly and/or the first negative electrode assembly may include a first electrolyte.

A second battery cell unit 212 may be disposed parallel with the first cell unit 210. Like the first cell unit 210, the second cell unit 212 may include a (second) positive electrode assembly separated from a (second) negative electrode assembly by a (second) separating layer 236. The second separating layer 236 may be the same as or different from the first separating layer 226. The second separating layer 236 and/or the second positive electrode assembly and/or the second negative electrode assembly may include a second electrolyte. The second electrolyte may be the same as or different from the first electrolyte. The first and second cell units 210, 212 may share the negative electrode current collector 232. The second cell unit 212 further includes a second electrode 223 (also referred to as a second negative electroactive material layer) disposed near or adjacent to a second side of the negative electrode current collector 232, where the second side is substantially parallel with the first side. The second negative electroactive material layer 223 may be the same as or different from the first negative electroactive material layer 222.

The second cell unit 212 also includes a positive electrode defined by a second positive electroactive material layer 235 disposed near to adjacent to a second positive electrode current collector 244. The second positive electrode current collector 244 may be the same as or different from the first positive electrode current collector 234. Like the second positive electroactive material layer 35 illustrated in FIG. 1, the second positive electroactive material layer 235 may include lithium manganese iron phosphates (LiMnₓFe₁₋ₓPO₄, where 0≤x≤1) (LMFP) (such as LiMn_{0.7}Fe_{0.3}PO₄, LiMn_{0.6}Fe_{0.4}PO₄, LiMn_{0.8}Fe_{0.2}PO₄, and/or LiMn_{0.75}Fe_{0.25}PO₄), lithium vanadium oxygen phosphates (LiₓVOPO₄, where 0≤x≤1) (such as LiVOPO₄ and/or Li₂VOPO₄), lithium vanadium phosphates (Li₃V₂(PO₄)₃), and/or lithium vanadium fluorophosphates (LiVPO₄F). In this manner, the battery 220 can include both nickel-rich cathodes and phosphate-based cathodes. The battery 220 may have a hybrid capacity ratio of the nickel-rich cathodes to the phosphate-based cathodes that is greater than or equal to 0:50 to less than or equal to about 50:0. The number of nickel-rich cathodes or cells and phosphate-based cathodes or cells will depend on the selected hybrid capacity ratio.

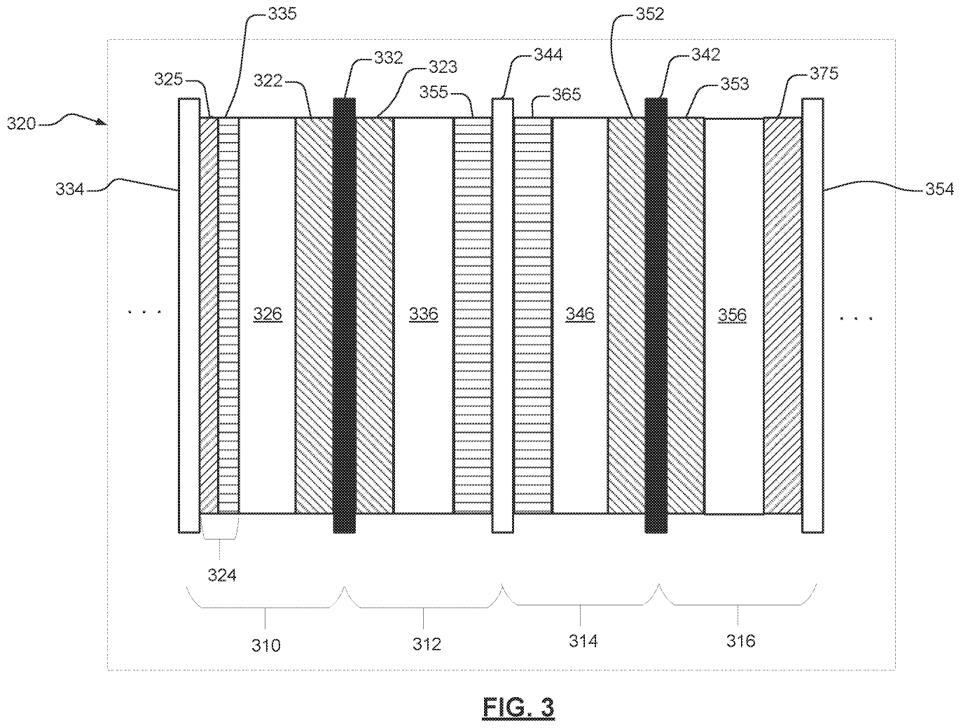

FIG. 3 illustrates another example electrochemical battery 320. The example battery 320 may include one or more negative electrodes 322, 323, 352, 353 together with one or more positive electrodes 324, 355, 365, 375. Although only four cell units 310, 312, 314, 316 are illustrated, it should be recognized, as illustrated by the ellipsis, that the present teachings also apply to various other battery configurations, including batteries fewer or more cell units.

A first battery cell unit 310 may include a first positive electrode current collector 334 and a first positive electrode 324 disposed near or adjacent to a surface of the first positive electrode current collector. Like positive electrode current collector 34 illustrated in FIG. 1, the first positive electrode current collector 334 may include a metal foil, metal grid or screen, expanded metal comprising aluminum, or any other appropriate electrically conductive material known to those of skill in the art. Like the positive electrode 24 illustrated in FIG. 1, the first positive electrode 324 may include a first positive electroactive material layer 325 and a second positive electroactive material layer 335. Although, as illustrated, the first positive electroactive material layer 325 is disposed near or adjacent to the first positive electrode current collector 334 and the second positive electroactive material layer 335 is disposed near or adjacent to a surface of the first positive electroactive material layer 325 away from the first positive electrode current collector, it should be recognized that in certain variations, the second positive electroactive material layer 335 may be disposed near or adjacent to the first positive electrode current collector, and the first positive electroactive material layer 325 may be disposed near or adjacent to a surface of the second positive electroactive material layer 335 away from the first positive electrode current collector.

In each instance, the first positive electroactive material layer 325 may include a nickel-rich positive electroactive material represented by:

LiM¹ₓM²_{y}M³_{z}M⁴_{(1-x-y-z)}O₂

where M¹, M², M³, and M⁴ are transitions metals (for example, independently selected from the group consisting of: nickel (Ni), manganese (Mn), cobalt (Co), aluminum(Al), and the like or combinations thereof), 0≤x≤1, 0≤y≤1, and 0≤z≤1. The second positive electroactive material layer 335 may include a phosphate-based positive electroactive material, such as lithium manganese iron phosphates (LiMnₓFe₁₋ₓPO₄, where 0≤x≤1) (LMFP) (such as LiMn_{0.7}Fe_{0.3}PO₄, LiMn_{0.6}Fe_{0.4}PO₄, LiMn_{0.8}Fe_{0.2}PO₄, and/or LiMn_{0.75}Fe_{0.25}PO₄), lithium vanadium oxygen phosphates (LiₓVOPO₄, where 0≤x≤1) (such as LiVOPO₄ and/or Li₂VOPO₄), lithium vanadium phosphates (Li₃V₂(PO₄)₃), and/or lithium vanadium fluorophosphates (LiVPO₄F).

The first cell unit 310 may also include a first negative electrode assembly defined by a negative electrode current collector 332 and a first negative electrode 322 (also referred to as a first negative electroactive material layer) disposed near or adjacent to a first side of the negative electrode current collector 332, which like the negative electrode current collector 32 illustrated in FIG. 1, may include a metal foil, metal grid or screen, expanded metal comprising aluminum, or any other appropriate electrically conductive material known to those of skill in the art. Further still, as in FIG. 1, a first separating layer 326 may physically separate the first positive electrode assembly and the first negative electrode assembly, and the separating layer 326 and/or the first positive electrode assembly and/or the first negative electrode assembly may include a first electrolyte.

A second battery cell unit 312 may be disposed parallel with the first cell unit 310. Like the first cell unit 310, the second cell unit 312 may include a second positive electrode assembly separated from a second negative electrode assembly by a second separating layer 336. The second separating layer 336 may be the same as or different from the first separating layer 326. The second separating layer 336 and/or the second positive electrode assembly and/or the second negative electrode assembly may include a second electrolyte. The second electrolyte may be the same as or different from the first electrolyte.

The first and second cell units 310, 312 may share the first negative electrode current collector 332. The second cell unit 312 further includes a second negative electrode 323 (also referred to as a second negative electroactive material layer) disposed near or adjacent to a second side of the first negative electrode current collector 332, where the second side is substantially parallel with the first side. The second negative electroactive material layer 323 may be the same as or different from the first negative electroactive material layer 322.

The second cell unit 312 also includes a second positive electrode 355 (also referred to as a third positive electroactive material layer) disposed near to adjacent to a second positive electrode current collector 344. The second positive electrode current collector 344 may be the same as or different from the first positive electrode current collector 334. The third positive electroactive material layer 355 may be the same as the first positive electroactive material layer 325 or the second positive electroactive material layer 335. For example, in certain variations, the third positive electroactive material layer 355 may be a phosphate-based cathode. In other variations, the third positive electroactive material layer 355 may be a nickel-rich cathode.

A third battery cell unit 314 may be disposed parallel with the first and second cell units 310, 312. Like the first and second cell units 310, 312, the third cell unit 314 may include a (third) positive electrode assembly separated from a (third) negative electrode assembly by a (third) separating layer 346. The third separating layer 346 may be the same as or different form the first separating layer 326 and/or the second separating layer 336. The third separating layer 346 and/or the third positive electrode assembly and/or the third negative electrode assembly may include a third electrolyte. The third electrolyte may be the same as or different form the first electrolyte and/or the second electrolyte.

The second and third cell units 312, 314 may share the second positive electrode current collector 344. The third cell 314 further includes a third positive electrode 365 (also referred to as fourth positive electroactive material layer) disposed near or adjacent to a second side of the second positive electrode current collector 344, where the second side is substantially parallel with the first side. The fourth positive electroactive material layer 365 may be the same as or different form the third positive electroactive material layer 355. For example, in certain variations, the fourth positive electroactive material layer 365 may be a phosphate-based cathode. In other variations, the fourth positive electroactive material layer 365 may be a nickel-rich cathode.

The third cell unit 314 also includes a third negative electrode 352 (also referred to as a third negative electroactive material layer) disposed near or adjacent to a second negative electrode current collector 342. The second negative electrode current collector 342 may be the same as or different from the first negative electrode current collector 332, and the third negative electroactive material layer 352 may be the same as or different from the first negative electroactive material layer 322 and/or the second negative electroactive material layer 323.

A fourth battery cell unit 316 may be disposed parallel with the first, second, and third cell units 310, 312, 314. Like the first, second, and third cell units 310, 312, 314, the fourth cell unit 316 may include a (fourth) positive electrode assembly separated from a (fourth) negative electrode assembly by a (fourth) separating layer 356. The fourth separating layer 356 may be the same as or different form the first separating layer 326 and/or the second separating layer 336 and/or the third separating layer 346. The fourth separating layer 356 and/or the fourth positive electrode assembly and/or the fourth negative electrode assembly may include a third electrolyte. The fourth electrolyte may be the same as or different form the first electrolyte and/or the second electrolyte and/or the third electrolyte.

The third and fourth cell units 312, 216 may share the second negative electrode current collector 342. The fourth cell unit 316 further includes a fourth negative electrode 353 (also referred to a fourth negative electroactive material layer) disposed near or adjacent to a second side of the second negative electrode current collector 342, where the second side is substantially parallel with the first side. The fourth negative electroactive material layer 353 may be the same as or different from the first negative electroactive material layer 322 and/or the second negative electroactive material layer 323 and/or the fourth negative electroactive material layer 352.

The fourth cell unit 316 also includes a fourth positive electrode 375 (also referred to as a fifth positive electroactive material layer) disposed near to adjacent to a third positive electrode current collector 354. The third positive electrode current collector 354 may be the same as or different from the first positive electrode current collector 334 and/or the second positive electrode current collector 344. The fifth positive electroactive material layer 375 may be the same as the first positive electroactive material layer 325 or the second positive electroactive material layer 335. For example, in certain variations, the fifth positive electroactive material layer 375 may be a phosphate-based cathode. In other variations, the fifth positive electroactive material layer 375 may be a nickel-rich cathode.

Certain features of the current technology are further illustrated in the following non-limiting examples.

### Example 1

Example batteries and battery cells may be prepared in accordance with various aspects of the present disclosure.

For example, an example battery 410 may include two or more battery cell units, where a first battery cell unit includes a first positive electroactive material layer, and a second battery cell unit includes a second positive electroactive material layer. The first positive electroactive material layer may include a nickel-rich positive electroactive material, and the second positive electroactive material layer may be a phosphate-based electroactive material. For example, the first positive electroactive material layer may include NCMA, and the second positive electroactive layer may include LiFe_{0.3}Mn_{0.7}PO₄. Each of the cell units of the example cell 410 may include a graphite-containing negative electrode. The example battery 410 may include a total of six cell units connected in parallel, including four first cell units and two second cell units. In certain variations, the two second cell units may be disposed near or adjacent each other near a middle of the example battery 410.

A comparative cell 420 may include two or more battery cell units, where each of the battery cell units includes the same positive electroactive material. For example, the cell units may include nickel-rich cathodes including nickel-rich positive electroactive materials, such as NCMA. Like the example battery 410, each of the cell units of the comparative cell 420 may include a graphite-containing negative electrode, and the comparative battery 420 may include a total of six cell units connected in parallel.

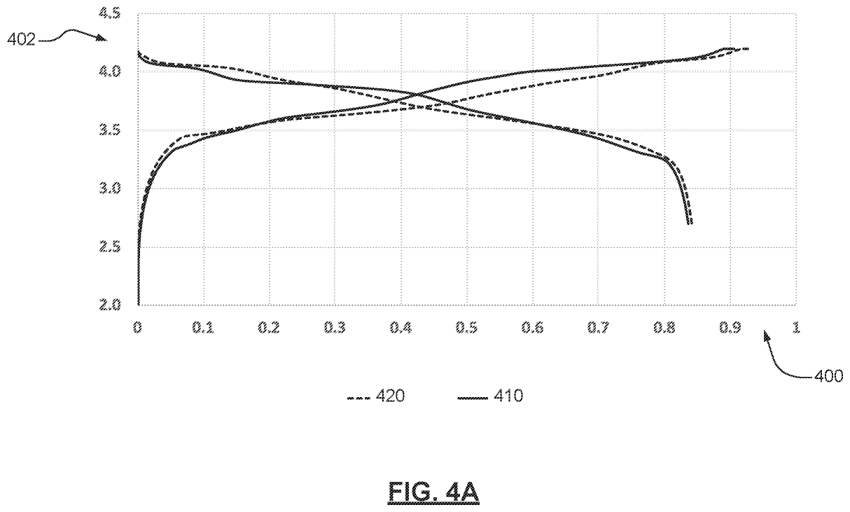

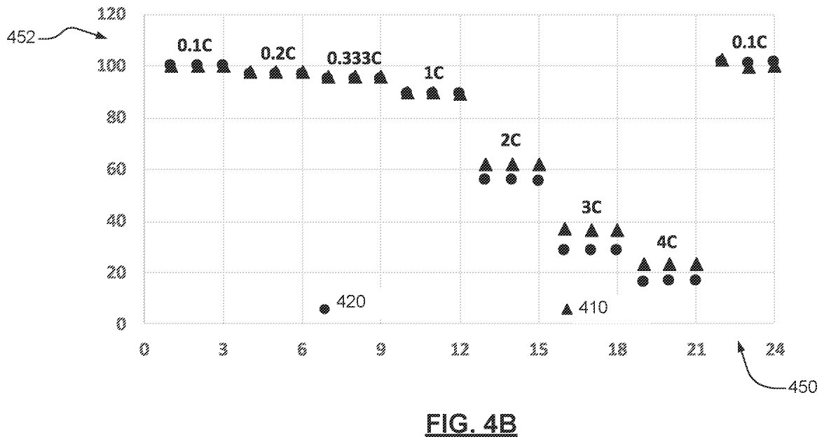

FIG. 4A is a graphical illustration demonstrating the initial charge and discharge curves at 0.05 C of the example cell 410 as compared to the comparative cell 420, where the x-axis 400 represents capacity (Ah), and the y-axis 402 represents voltage (V). As illustrate, the example cell 410 (having a similar design as the battery 220 illustrated in FIG. 2) shows enhanced initial coulombic efficiency. For example, the example cell 410 may have a columbic efficiency (CE) after a first cycle of about 92.32%, while the comparative cell has a columbic efficiency (CE) after a first cycle of about 90.67%.

FIG. 4B is a graphical illustration demonstrating the discharge rate (charge at 0.2 C) of the example cell 410 as compared to the comparative cell 420, where the x-axis 450 represents cycle number, and the y-axis 452 represents capacity retention (%). As illustrate, the example cell 410 (having a similar design as the battery 220 illustrated in FIG. 2) has improved capacity retention, and as such, better fast discharge capability.

The example cell 410 also has optimized thermal stability under abuse conditions as compared to the comparative cell 420, which can be attributed to the intrinsically thermal stable properties of the phosphate-based electroactive materials that possess higher decomposition onset temperature. That is, the second positive electroactive material of the example cell 410 may act as a thermal blocking layer, resulting in more uniform thermal distribution.

### Example 2

Example batteries and battery cells may be prepared in accordance with various aspects of the present disclosure.

For example, an example battery 510 may include a positive electrode having a first positive electroactive material layer and a second positive electroactive material layer that is different from the first positive electroactive material layer. The first positive electroactive material layer may include, for example, a nickel-rich positive electroactive material, and the second positive electroactive material layer may include a phosphate-based positive electroactive material. For example, the first electroactive material layer may include LiNi₇₅Mn₂₅O₂, and the second electroactive material layer may include LiMn_{0.7}Fe_{0.3}PO₄. The example battery 510 may include a graphite-containing negative electrode.

A comparative cell 520 may include a positive electrode also including nickel-rich positive electroactive material, such as LiNi₇₅Mn₂₅O₂. The comparative cell 520 may also include a graphite-containing negative electrode.

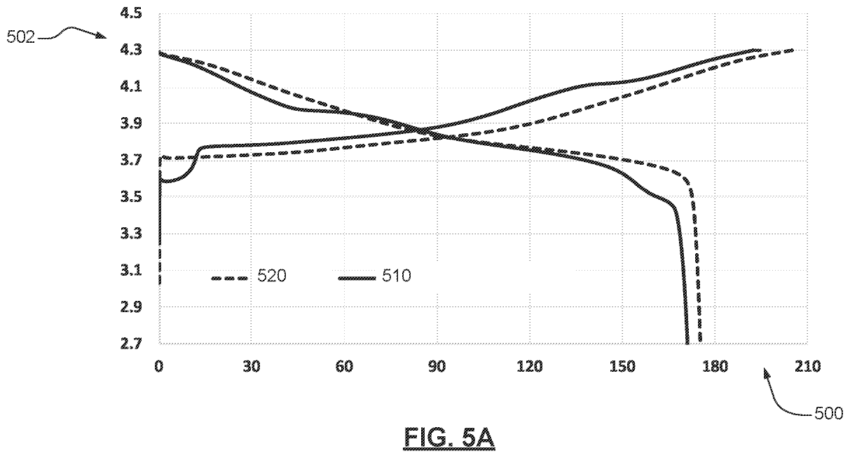

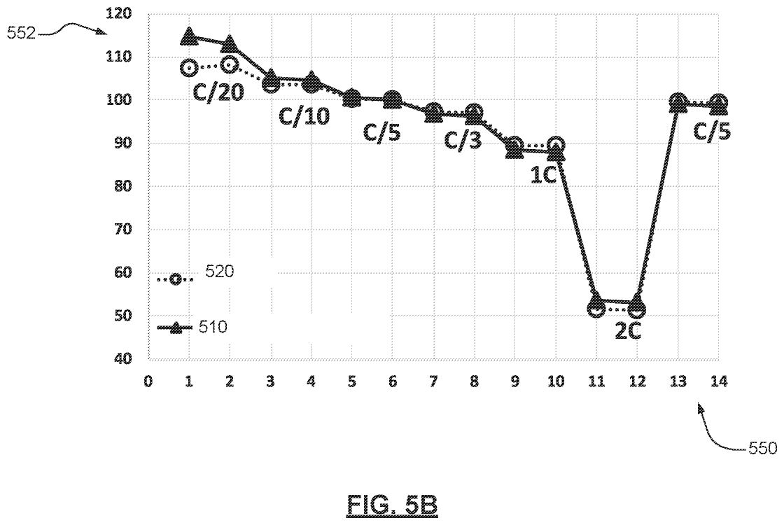

FIG. 5A is a graphical illustration demonstrating the initial charge and discharge curves of the example cell 510 as compared to the comparative cell 520, where the x-axis 500 represents specific capacity (mAh·g⁻¹), and the y-axis 502 represents voltage (V). As illustrate, the example cell 510 (having a similar design as the battery 20 illustrated in FIG. 1) shows enhanced initial coulombic efficiency. For example, the example cell 510 may have a columbic efficiency (CE) after a first cycle of about 87.52%, while the comparative cell has a columbic efficiency (CE) after a first cycle of about 84.80%.

FIG. 5B is a graphical illustration demonstrating the discharge rate (charge at 0.2 C) of the example cell 510 as compared to the comparative cell 520, where the x-axis 550 represents cycle number, and the y-axis 552 represents capacity retention (%). As illustrate, the example cell 510 (having a similar design as the battery 20 illustrated in FIG. 1) has improved capacity retention, and as such, better fast discharge capability.

Further, like the example cell 410, the example cell 510 also has optimized thermal stability under abuse conditions as compared to the comparative cell 520, which can be attributed to the intrinsically thermal stable properties of the phosphate-based electroactive materials that possess higher decomposition onset temperature. That is, the second positive electroactive material of the example cell 510 may act as a thermal blocking layer, resulting in more uniform thermal distribution.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrochemical device that cycles lithium ions, the electrochemical device comprising:
at least one first cell unit comprising a nickel-rich positive electroactive material represented by:
LiM¹ₓM²_{y}M³_{z}M⁴_{(1-x-y-z)}O₂
where M¹, M², M³, and M⁴ are each a transition metal independently selected from the group consisting of: nickel (Ni), manganese (Mn), cobalt (Co), aluminum (Al), and combinations thereof, where 0≤x≤1, 0≤y≤1, and 0≤z≤1; and
at least one second cell unit comprising a phosphate-based positive electroactive material selected from the group consisting of: lithium manganese iron phosphates (LiMnₓFe₁₋ₓPO₄, where 0≤x≤1) (LMFP), lithium vanadium oxygen phosphates (LiₓVOPO₄, where 0≤x≤1), lithium vanadium phosphates, lithium vanadium fluorophosphates, and combinations thereof.

2. The electrochemical device of claim 1, wherein the nickel-rich positive electroactive material defines a first positive electroactive material layer and the at least one first cell unit further comprises a first negative electroactive material layer physically separated from the first positive electroactive material layer by a first separating layer, the phosphate-based positive electroactive material defines a second positive material layer and the at least one second cell unit further comprises a second negative electroactive material layer physically separated from the second positive electroactive material layer by a second separating layer, the first and second negative electroactive material layers are the same or different, and the first and second separating layers being the same or different.

3. The electrochemical device of claim 1, wherein the nickel-rich positive electroactive material defines a first nickel-rich positive electroactive material layer, the phosphate-based positive electroactive material defines a first phosphate-based positive electroactive material layer, and the at least one second cell unit further comprises a second nickel-rich positive electroactive material layer disposed near or adjacent to the first phosphate-based positive electroactive material layer.

4. The electrochemical device of claim 3, wherein the at least one first cell unit further comprises a second phosphate-based positive electroactive material layer disposed near or adjacent to the first nickel-rich positive electroactive material layer.

5. The electrochemical device of claim 1, wherein the phosphate-based positive electroactive material defines a first phosphate-based positive electroactive material layer, the nickel-rich positive electroactive material defines a first nickel-rich positive electroactive material layer, and the at least one first cell unit further comprises a second phosphate-based positive electroactive material layer disposed near or adjacent to the first nickel-rich positive electroactive material layer.

6. The electrochemical device of claim 1, wherein a capacity ratio of the nickel-rich positive electroactive material to the phosphate-based positive electroactive material is greater than or equal to about 0% to less than or equal to about 50%.

7. The electrochemical device of claim 1, wherein the nickel-rich positive electroactive material defines a nickel-rich positive electroactive material layer, and the nickel-rich positive electroactive material layer further comprises a second electroactive material selected from the group consisting of a layered oxide represented by LiMeO₂, an olivine-type oxide represented by LiMePO₄, a monoclinic-type oxide represented by Li₃Me₂(PO₄)₃, a spinel-type oxide represented by LiMe₂O₄, a tavorite represented by LiMeSO₄F, a tavorite represented by LiMePO₄F, wherein Me is a transition metal selected from the group consisting of: cobalt (Co), nickel (Ni), manganese (Mn), iron (Fe), aluminum (Al), vanadium (V), and combinations thereof.

8. The electrochemical device of claim 7, wherein a mass ratio of the nickel-rich positive electroactive material to the second electroactive material is greater than or equal to about 5:95 to less than or equal to about 95:5.

9. The electrochemical device of claim 1, wherein the phosphate-based positive electroactive material defines a phosphate-based positive electroactive material layer, and the phosphate-based positive electroactive material layer further comprises a second electroactive material selected from the group consisting of: a layered oxide represented by LiMeO₂, an olivine-type oxide represented by LiMePO₄, a monoclinic-type oxide represented by Li₃Me₂(PO₄)₃, a spinel-type oxide represented by LiMe₂O₄, a tavorite represented by LiMeSO₄F, a tavorite represented by LiMePO₄F, wherein Me is a transition metal selected from the group consisting of: cobalt (Co), nickel (Ni), manganese (Mn), iron (Fe), aluminum (Al), vanadium (V), and combinations thereof.

10. The electrochemical device of claim 9, wherein a mass ratio of the phosphate-based positive electroactive material to the second electroactive material is greater than or equal to about 5:95 to less than or equal to about 95:5.

11. An electrochemical device that cycles lithium ions, the electrochemical device comprising:
a first positive electrode comprising a nickel-rich positive electroactive material represented by:
LiM¹ₓM²_{y}M³_{z}M⁴_{(1-x-y-z)}O₂
where M¹, M², M³, and M₄ are each a transition metal independently selected from the group consisting of: nickel (Ni), manganese (Mn), cobalt (Co), aluminum (Al), and combinations thereof, where 0≤x≤1, 0≤y≤1, and 0≤z≤1;
a first negative electrode disposed parallel with the first positive electrode and comprising a first negative electroactive material;
a first separating layer disposed between the first positive electrode and the first negative electrode;
a second positive electrode disposed parallel with the first positive electrode and the first negative electrode and comprising a phosphate-based positive electroactive material selected from the group consisting of: lithium manganese iron phosphates (LiMnₓFe₁₋ₓPO₄, where 0≤x≤1) (LMFP), lithium vanadium oxygen phosphates (LiₓVOPO₄, where 0≤x≤1), lithium vanadium phosphates, lithium vanadium fluorophosphates, and combinations thereof;
a second negative electrode disposed parallel with the second positive electrode and comprising a second negative electroactive material, the second negative electroactive material being the same as or different from the first negative electroactive materials, and
a second separating layer disposed between the second positive electrode and the second negative electrode, the first and second separating layers being the same or different.

12. The electrochemical device of claim 11, wherein the nickel-rich positive electrode material defines a first nickel-rich positive electrode material layer, and the phosphate-based positive electroactive material defines a first phosphate-based positive electroactive material layer, and the at least one first positive electrode further comprises a second phosphate-based positive electroactive material layer disposed near or adjacent to the first nickel-rich positive electrode material layer.

13. The electrochemical device of claim 12, wherein the at least one second positive electrode further comprises a second nickel-rich positive electrode material layer disposed near or adjacent to the first phosphate-based positive electroactive material layer.

14. The electrochemical device of claim 11, wherein a capacity ratio of the nickel-rich positive electroactive material to the phosphate-based positive electroactive material is greater than or equal to about 0% to less than or equal to about 50%.

15. The electrochemical device of claim 11, wherein the nickel-rich positive electroactive material defines a nickel-rich positive electroactive material layer, and the nickel-rich positive electroactive material layer further comprises a second electroactive material selected from the group consisting of: a layered oxide represented by LiMeO₂, an olivine-type oxide represented by LiMePO₄, a monoclinic-type oxide represented by Li₃Me₂(PO₄)₃, a spinel-type oxide represented by LiMe₂O₄, a tavorite represented by LiMeSO₄F, a tavorite represented by LiMePO₄F, wherein Me is a transition metal selected from the group consisting of: cobalt (Co), nickel (Ni), manganese (Mn), iron (Fe), aluminum (Al), vanadium (V), and combinations thereof.

16. The electrochemical device of claim 15, wherein a mass ratio of the nickel-rich positive electroactive material to the second electroactive material is greater than or equal to about 5:95 to less than or equal to about 95:5.

17. The electrochemical device of claim 11, wherein the phosphate-based positive electroactive material defines a phosphate-based positive electroactive material layer, and the phosphate-based positive electroactive material layer further comprises a second electroactive material selected from the group consisting of: a layered oxide represented by LiMeO₂, an olivine-type oxide represented by LiMePO₄, a monoclinic-type oxide represented by Li₃Me₂(PO₄)₃, a spinel-type oxide represented by LiMe₂O₄, a tavorite represented by LiMeSO₄F, a tavorite represented by LiMePO₄F, wherein Me is a transition metal selected from the group consisting of: cobalt (Co), nickel (Ni), manganese (Mn), iron (Fe), aluminum (Al), vanadium (V), and combinations thereof.

18. The electrochemical device of claim 17, wherein a mass ratio of the phosphate-based positive electroactive material to the second electroactive material is greater than or equal to about 5:95 to less than or equal to about 95:5.

19. An electrode assembly for an electrochemical cell that cycles lithium ions, the electrode comprising:
a current collector;
a first electroactive material layer disposed on or near the current collector; and
a second electroactive material layer disposed on or near a surface of the first electroactive material layer on a side opposite to the current collector,
the first electroactive material layer comprising one of a nickel-rich positive electroactive material and a phosphate-base positive electroactive material, and the second electroactive material layer comprising the other of the nickel-rich positive electroactive material and the phosphate-based positive electroactive material,
the nickel-rich positive electroactive material represented by:
LiM¹ₓM²_{y}M³_{z}M⁴_{(1-x-y-z)}O₂
where M¹, M², M³, and M⁴ are each a transition metal independently selected from the group consisting of: nickel (Ni), manganese (Mn), cobalt (Co), aluminum (Al), and combinations thereof, wherein 0≤x≤1, 0≤y≤1, and 0≤z≤1, and
the phosphate-based positive electroactive material selected from the group consisting of: lithium manganese iron phosphates (LiMnₓFe₁₋ₓPO₄, where 0≤x≤1) (LMFP), lithium vanadium oxygen phosphates (LiₓVOPO₄, where 0≤x≤1), lithium vanadium phosphates, lithium vanadium fluorophosphates, and combinations thereof.

20. The electrode of claim 19, wherein a capacity ratio of the nickel-rich positive electroactive material to the phosphate-based positive electroactive material is greater than or equal to about 0% to less than or equal to about 50%.
